(19) United States
(12) Patent Application Publication
(10) Pub. No.: US 2026/0217293 A1
(43) Pub. Date: Jul. 30, 2026

(54) SYSTEM AND METHOD FOR VEHICLE CONTROL

(71) Applicant: Transportation IP Holdings, LLC, Norwalk, CT (US)

(72) Inventors: Jeff Kernwein, Norwalk, CT (US); Jared Little, Norwalk, CT (US)

(73) Assignee: Transportation IP Holdings, LLC, Norwalk, CT (US)

(21) Appl. No.: 19/037,228

(22) Filed: Jan. 26, 2025

(51) Int. Cl. B61L 27/16; B60W 30/18; B61L 27/14; B61L 27/57; G07C 5/02

(52) U.S. Cl. CPC B61L 27/16; B61L 27/14; B61L 27/57; G07C 5/02; B60W 30/18054; B60W 2510/0604; B60W 2510/18; B60W 2554/4041; B60W 2710/18; B60W 2720/10

(57) ABSTRACT

A system includes a control circuit configured to determine a combined fuel consumption value for a first vehicle and a second vehicle, based at least in part on a first vehicle fuel consumption value and a second vehicle fuel consumption value, with both the first and second vehicles traveling towards, and then through, a common location.

### TECHNICAL FIELD

Embodiments in the disclosure relate to a system and a method for controlling vehicle movement.

### Discussion of Art

When vehicles travel along a shared route and arrive at a common location, one may remain idle while the other approaches and passes through the common location. A siding track or a crossing may be used to idle one vehicle and to permit another vehicle to pass. However, idling consumes fuel, takes time, and may add to operational costs. At least some existing solutions rely on basic scheduling mechanisms or static routing. These may fail to account for real-time fuel consumption or dynamic trip profiles, may not prioritize correctly, and may not accurately determine time to clear the meeting. This inefficiency may lead to unnecessary idling or suboptimal passing sequences, contributing to increased fuel usage. It may be desirable to have a system and method that differs from those that are currently available.

### BRIEF DESCRIPTION

A system includes: a control circuit configured to determine a combined fuel consumption value for a first vehicle and a second vehicle, based at least in part on a first vehicle fuel consumption value and a second vehicle fuel consumption value, with both the first and second vehicles traveling towards, and then through, a common location. The combined fuel consumption determination may be based on at least, a moving fuel consumption value for moving each of the first and second vehicles through the common location, and an idling fuel consumption rate for both the first and second vehicles.

A system includes: a control circuit that determines a combined fuel consumption value for a first vehicle and a second vehicle that are both intended to travel through a common location, based at least in part on first vehicle fuel consumption value that is associated with the first vehicle, and second vehicle fuel consumption value that is associated with the second vehicle, the combined fuel consumption may include: a moving fuel consumption value for moving through the common location; and an idling fuel consumption value for idling at the common location; and the control circuit being further configured to direct one or the other of the first vehicle or the second vehicle to idle at or near the common location based at least in part on a determined collective fuel consumption value for both the first vehicle and the second vehicle.

A method, includes: determining which of a first vehicle and a second vehicle will have priority to move through a common location on a route based at least in part on a predicted first vehicle fuel consumption value for a first vehicle to traverse a route toward and through a common location, and a predicted second vehicle fuel consumption value for the second vehicle to traverse the route toward and through the common location; and the predicted fuel consumption amount is based at least in part on: a moving fuel consumption amount for moving the first and second vehicle through the common location; and an idling fuel consumption amount for idling the first and second vehicles at the common location for the period where the other vehicle traverses the common location.

### BRIEF DESCRIPTION OF THE DRAWINGS

FIG. 1 illustrates a system according to at least one aspect of the following disclosure.

FIG. 2 illustrates vehicles traveling toward a common location in accordance with the system of FIG. 1.

FIG. 3 illustrates vehicles traveling toward a common location in accordance with the system of FIG. 1.

FIG. 4 illustrates a flowchart of a method according to one embodiment.

FIG. 5 illustrates a flowchart of a method according to one embodiment.

### DETAILED DESCRIPTION

Aspects of the present disclosure relate to controlling vehicle travel. In one embodiment, a determination may be made for a meeting of two vehicles at a common location. The inventive system may control, with an intent to improve or optimize, a meet-and-pass event of two vehicles at a common location. This may, for example, reduce fuel consumption, reduce time to complete, and increase operational efficiency.

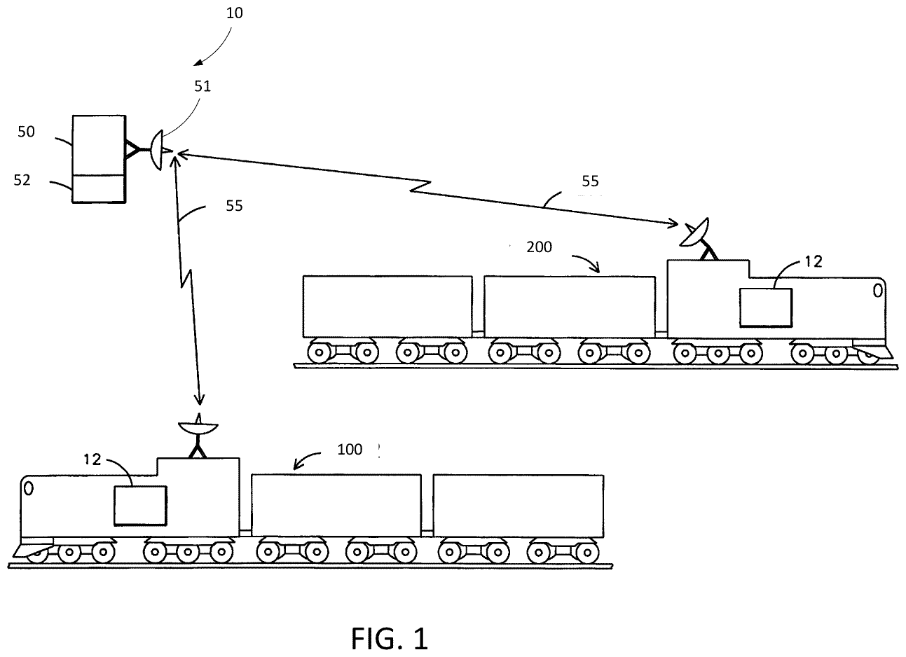

Referring to FIGS. 1-4, a system 10 includes a control circuit 50 that may execute a method 60 that determines 61, estimates, or calculates a combined fuel consumption value associated with a plurality of vehicles (e.g., a first vehicle 100 and a second vehicle 200) that travel through a common location. The combined fuel consumption value may include a moving fuel consumption value for passing through the common location and an idling fuel consumption value for idling at the common location. The control circuit may analyze 62 data associated with the plurality vehicles to determine the combined fuel value. Such data may include trip profiles, motion parameters, load parameters, and/or fuel consumption parameters.

The system may further include a wireless communication system 51 that facilitates data transmission 55 between the control circuit and one or more of the plurality of vehicles. Moreover, a data collection system 52 may provide operational conditions about one or more of the plurality of vehicles to the control circuit. While illustrated as an offboard component interacting with an onboard control system 12 of the plurality of vehicles, the control circuit may be incorporated into the onboard control system of one of the plurality of vehicles, and may communicate with an onboard control system of another vehicle to determine a combined fuel consumption value.

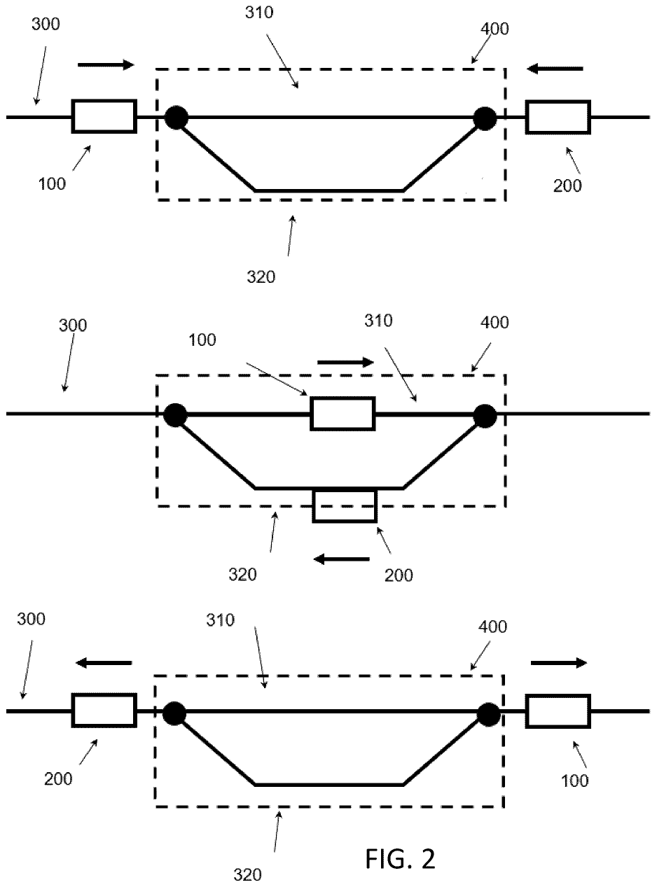

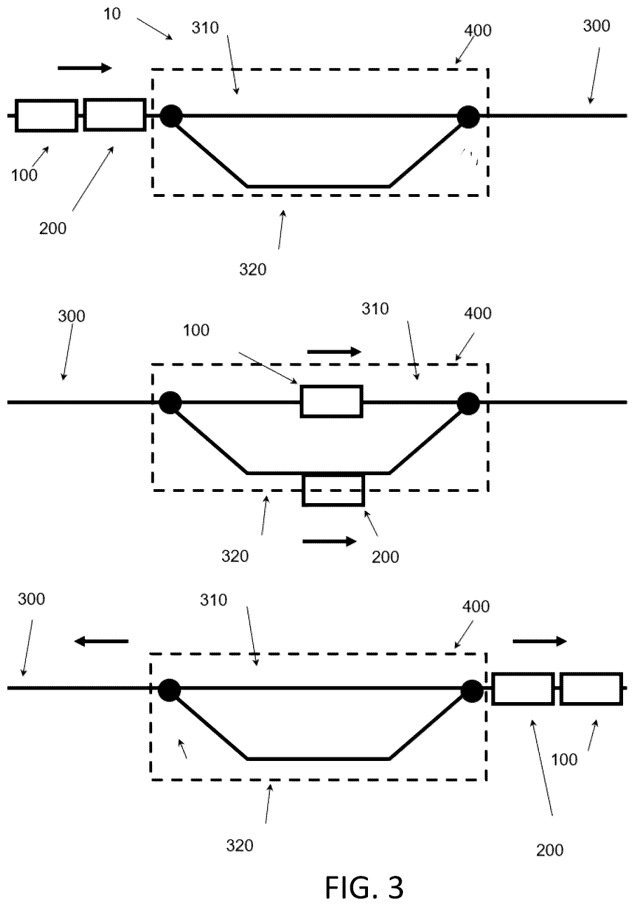

In one embodiment, as illustrated in FIGS. 2 and 3, the first vehicle and the second vehicle may both travel along a route 300 in the same direction (FIG. 1), or in opposite directions (FIG. 2), through a common location 400. The first vehicle and the second vehicle may meet with each other on the route at the common location. For example, a section of the route at the common location may define a mainline 310 and a siding 320. The control circuit may select 63 one of the first vehicle or the second vehicle for idling based on the combined fuel consumption value. As such, the control circuit may select the first vehicle to travel along the route, enter and pass through the mainline at the common location, and the second vehicle to travel along the route, fully enter and idle on the siding at the common location before the first vehicle arrives at the mainline to allow the first vehicle to pass through the mainline without interruption, or vice versa.

In one embodiment, the control circuit may determine a combined fuel consumption value for the first vehicle moving through the common location while the second vehicle idles and allows the first vehicle to pass, and a second combined fuel consumption value for the second vehicle moving through the common location while the first vehicle idles and allows the second vehicle to pass. The control circuit may then compare the determined combined fuel consumption values and, select one of the first vehicle or the second vehicle for idling based at least in part on the comparison. Additionally, or alternatively, the control circuit may compare the fuel consumption to a determined threshold and select a vehicle for idling and another for passing through based at least in part on the comparison. The determined threshold may be stored in a database accessible by the control circuit. In one embodiment, the determined threshold may be a fuel consumption threshold.

In one embodiment, additionally or alternatively, the control circuit may select one of the first vehicle and the second vehicle to idle at the common location based at least in part on that the one of the first vehicle and the second vehicle may have an auto engine start stop (AESS) unit. Vehicles equipped with an AESS unit can automatically shut down their engine while idling and restart it when necessary, leading to significant fuel savings. The control circuit may prioritize idling the vehicle with the AESS unit, as this reduces fuel consumption and emissions during idle periods. This feature enables the system to further optimize fuel efficiency by leveraging available technological advantages, such as automatic engine shutdown, to minimize unnecessary fuel usage at the common location.

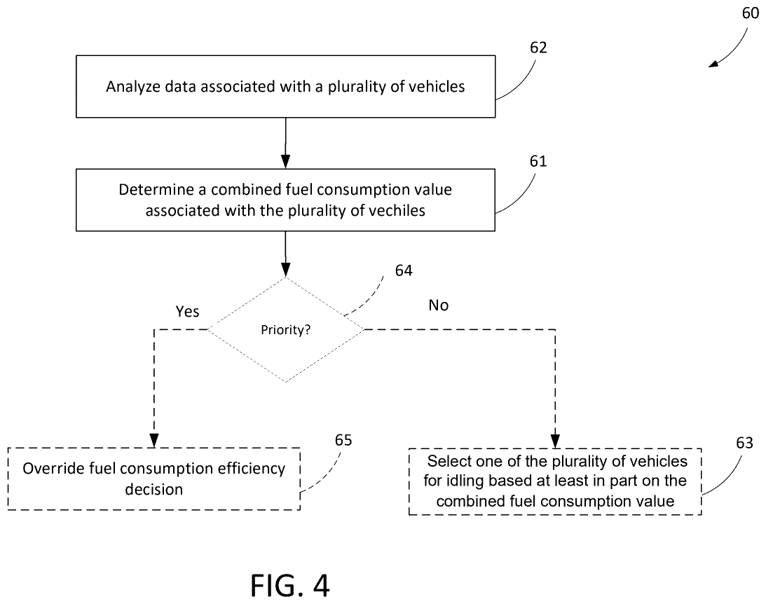

In one embodiment, as illustrated in FIG. 4, the control circuit may additionally or alternatively utilize a priority-based decision-making process to select which vehicle will idle at the common location and may override 65 a selection based on fuel consumption efficiency based on priority 64. The first vehicle fuel consumption value received from the first vehicle may include a first priority value associated with the first vehicle, and the second vehicle fuel consumption value received from the first vehicle may include a second priority value for the second vehicle. These priority values may be based on one or more factors such as the type of vehicle (e.g., passenger vs. freight), the lost momentum (longer trains may require more energy to start/stop), the nature of the routes traveled by the two vehicles, whether one or both of the vehicle include an automatic vehicle start/stop (AESS) system, urgency of arrival, or operational schedules.

The control circuit may compare the first and second priority values to determine which vehicle has a higher priority. If the first vehicle has a higher priority, the system will instruct the second vehicle to idle at the common location, allowing the first vehicle to pass. Conversely, if the second vehicle's priority is higher, the first vehicle will idle. This decision may be made dynamically, ensuring that operational priorities, such as adherence to tight schedules or urgent deliveries, are respected while still optimizing fuel consumption.

In one embodiment, the control circuit may detect that one of the two vehicles includes an AESS, designed to monitor the vehicle and automatically shut down the engine to save fuel. In such instance, the control circuit may select the vehicle with the AESS for idling/stopping at the common location.

Additionally, the system may integrate dynamic priority adjustments based on changes in trip profiles, such as delays or unexpected changes in cargo. For instance, if a freight vehicle initially had a lower priority but experiences a critical delivery delay, the control circuit may adjust its priority value to allow it to pass through the common location. This flexibility ensures the system remains adaptable to changing conditions while maintaining operational efficiency.

In one embodiment, the system prioritizes vehicles based on their type, such as passenger or freight. For example, the first vehicle may be a passenger vehicle, and the second vehicle may be a freight or cargo vehicle. In this case, the control circuit may assign a higher priority to the passenger vehicle compared to the freight vehicle. This prioritization is based on the typical urgency of passenger schedules, which often require tighter adherence to timetables compared to freight, allowing the passenger vehicle to pass through the common location while the freight vehicle idles. Conversely, if the second vehicle is the passenger vehicle and the first vehicle is the freight vehicle, the system applies the same logic, allowing the passenger vehicle to pass due to its higher priority. In both scenarios, the control circuit dynamically assigns priority based on operational requirements and predefined policies, ensuring that passenger vehicles are favored when making decisions at the common location.

As a result, the system optimizes for punctuality without sacrificing fuel efficiency, as idling the freight vehicle typically incurs a lower operational cost in terms of passenger experience. Moreover, the system is adaptable to specific situations where a freight vehicle might be given priority, such as in cases of high-value cargo with critical delivery times. In such cases, the control circuit may adjust the default priority settings to reflect the urgency of the situation, ensuring that operational demands are always met with the most efficient routing and scheduling decisions.

In another embodiment, the system accounts for the load weight carried by each vehicle to determine which vehicle should idle. The first vehicle may carry a lighter load, while the second vehicle may carry a heavier load. The control circuit calculates the energy required for braking and the impact of idling for each vehicle. For a vehicle with a heavier load, more energy is required to decelerate and re-accelerate, making it more fuel-efficient for that vehicle to continue moving through the common location rather than idle.

In this scenario, the control circuit selects the first vehicle with the lighter load to idle at the common location, allowing the second vehicle with the heavier load to pass through. This decision is made because the braking and restarting energy cost for the second vehicle would be higher due to its heavier load, thereby making idling the lighter vehicle a more fuel-efficient option.

On the other hand, if the first vehicle carries a heavier load and the second vehicle carries a lighter load, the control circuit adjusts the decision accordingly. The heavier first vehicle is given priority to pass, while the second vehicle, with its lighter load, idles at the common location. This optimization reduces the total energy expenditure involved in stopping and restarting the vehicles.

This load-based decision-making ensures that the system minimizes fuel consumption and energy waste, especially for vehicles carrying substantial loads. By taking into account the energy dynamics of heavy and light vehicles, the control circuit ensures that the vehicle with the lower energy cost for braking and restarting is selected to idle. This method also provides the flexibility to adjust priorities based on load type, such as perishable goods, where urgency may override energy considerations.

The system may account for the length of the first vehicle and the second vehicle when determining which vehicle should idle at the common location. Priority values may be assigned based on the length of the vehicles.

In one embodiment, first vehicle has a first length, and the second vehicle has a second length. The control circuit may compare these vehicle lengths with the siding length available on the siding route at the common location. If the first vehicle has a shorter length than the second vehicle, the control circuit may assign a lower priority to the first vehicle, instructing it to idle at the common location. This decision is made because shorter vehicles are often easier to fit into the siding route, minimizing logistical complications. Conversely, if the first vehicle has a longer length than the second vehicle, the system assigns it a higher priority and allows it to pass through the common location, while the second vehicle idles. This configuration ensures that the vehicle best suited for the available siding space is selected to idle, optimizing the use of the infrastructure and reducing potential bottlenecks caused by vehicle size mismatches.

The system may also compare each vehicle's length to the siding length of the available route. For instance, if the first vehicle's length is shorter than the siding length, but the second vehicle's length exceeds the siding length, the control circuit may then instruct the first vehicle to idle at the siding. In this case, the second vehicle, being too long to fit within the siding, will be prioritized to pass through the common location using the mainline route.

By incorporating vehicle length and siding length comparisons, the system ensures that vehicles are allocated to the siding track in a way that optimizes space usage and prevents inefficient use of infrastructure. This method is particularly useful when dealing with trains or other large vehicles where differences in length can significantly impact the ability to utilize sidings effectively.

Additionally, the system may perform dynamic length-based adjustments. If, for example, the system detects changes in the available siding length due to temporary conditions (e.g., maintenance or obstructions), it can reassign priorities dynamically. This flexibility prevents delays and ensures that each vehicle passes through the common location as efficiently as possible, considering both fuel efficiency and physical constraints.

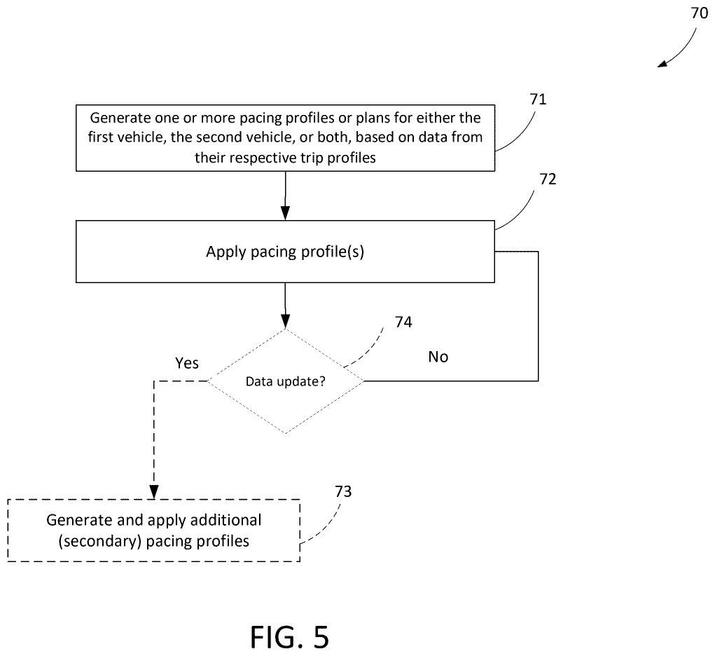

Referring to FIG. 5, the control circuit may execute a method 70 to optimize fuel consumption to reduce a combined fuel consumption amount associated with travel the first vehicle and the second vehicle to the common location and idling at the common location. The control circuit may generate 71 one or more pacing profiles or plans for either the first vehicle, the second vehicle, or both, based on data from their respective trip profiles. The first vehicle fuel consumption value associated with the first vehicle and the second vehicle fuel consumption value associated with the second vehicle may be analyzed by the control circuit to adjust their speeds and arrival times at the common location. By applying 72 the pacing profiles, the system can alter the vehicles'arrival times, reducing unnecessary waiting and optimizing fuel consumption. The pacing profiles may aim to minimize both the moving fuel consumption value and the idling fuel consumption value, ensuring that vehicles pass through the common location efficiently.

After applying the initial pacing profile to one or both vehicles, the control circuit may further dynamically generate 73 and applying additional pacing profiles based on data updates 74. These secondary pacing profiles further refine the vehicles'speeds and arrival times, ensuring continued fuel efficiency as conditions change. This adaptability allows the system to maintain optimal fuel use, regardless of unexpected delays or schedule changes.

According to one embodiment, the first vehicle may be expected to arrive at the common location at an initial Estimated Time of Arrival (ETA). Without any intervention, the first vehicle would idle at the common location for a first period of time, waiting for the second vehicle to arrive and pass. However, the control circuit generates the pacing profile to reduce the speed of the first vehicle, provided the reduced speed remains above a predefined minimum speed threshold. As a result, the first vehicle's arrival time is delayed, now reaching the common location at a second ETA, later than the original. This later arrival reduces the idle time, and the system ensures that the new arrival time does not violate any preset scheduling criteria.

Consequently, the time spent idling by the first vehicle is reduced, lowering its idling fuel consumption value. Additionally, the pacing profile may decrease the first vehicle's traveling fuel consumption by reducing its speed along the route. The operator's service time may also be considered, ensuring that any increase in travel time due to the lower speed stays within a maximum allowable service time limit. Overall, the first vehicle's fuel efficiency may be improved by balancing arrival time, idle time, and speed adjustments.

The control circuit may further generate a secondary pacing profile for the second vehicle. This pacing profile may also slow down the second vehicle, provided its new speed is within acceptable limits, and adjusts its arrival at the common location. By delaying the second vehicle's arrival, its moving fuel consumption value is reduced, allowing both vehicles to arrive at the common location in a more synchronized and fuel-efficient manner.

When both pacing profiles are applied, the second vehicle arrives at a slightly delayed time, but this delay remains acceptable under the system's scheduling criteria. The second vehicle can then pass through the common location without additional fuel costs associated with high speeds. Meanwhile, the first vehicle, having arrived later than initially expected, idles for a shorter duration, maintaining a reduced idling fuel consumption value.

The overall result is a coordinated decrease in both moving and idling fuel consumption for both vehicles. This method ensures that both vehicles adjust their speeds and idle times in a way that maximizes efficiency. In similar scenarios, the second vehicle may idle at the common location to allow the first vehicle to pass, and the pacing profiles can be adjusted accordingly to ensure optimal fuel consumption for both vehicles.

By implementing these pacing profiles dynamically, the system is capable of continuously optimizing vehicle performance and fuel efficiency, accounting for both real-time changes and predefined operational constraints. This ensures that fuel consumption is minimized whether vehicles are idling or traveling, while still adhering to necessary scheduling requirements.

In another embodiment, the control circuit may determine, based on the first vehicle fuel consumption value and second vehicle fuel consumption value, that the first vehicle is to arrive at the common location at an initial estimated time and is to idle for a first period of time, awaiting the arrival of the second vehicle. The second vehicle then passes through the common location while the first vehicle remains idle. To optimize combined fuel consumption, the control circuit may generate a pacing profile for the second vehicle, which increases its speed. This speed increase is allowed, provided it remains below a predefined maximum speed threshold, ensuring safety and efficiency. As a result, the second vehicle arrives at the common location earlier than it would have without the pacing profile, and this earlier arrival is acceptable if it does not violate any preset scheduling criteria.

With the second vehicle arriving sooner, the idle time of the first vehicle is reduced, meaning it waits for a second, shorter period of time. Consequently, the idling fuel consumption for the first vehicle is decreased, as the shortened idle time reduces unnecessary fuel expenditure. Additionally, since the second vehicle now passes through the common location more quickly, overall traffic flow is improved.

Additionally, the control circuit may generate a second pacing profile for the first vehicle in addition to the one applied to the second vehicle. This second pacing profile may slow down the first vehicle, which may reduce its moving fuel consumption, but cause it to arrive at the common location later than initially expected. This delay is acceptable as long as it does not violate the scheduling constraints for the first vehicle. With the pacing plan applied, the first vehicle spends even less time idling while waiting for the second vehicle to pass, further reducing fuel consumption. The service time for the operator of the first vehicle may also be factored by the control circuit in generating and/or applying the pacing profiles.

In one embodiment, additionally or alternatively, the control circuit may modify operational settings of either the first vehicle, the second vehicle, or both, to optimize fuel consumption. These operational settings may include adjustments to one or more of the following parameters: throttle setting, brake setting, moving speed, tractive effort, and power output. By modifying these settings, the control circuit may reduce both the moving fuel consumption and the idling fuel consumption. For example, by adjusting the throttle setting and tractive effort, the system may reduce the power required for acceleration, leading to lower fuel use when the vehicle is in motion. Similarly, reducing the power output while idling can minimize fuel waste during waiting periods at the common location.

The system may dynamically adjust these parameters based on the specific conditions and requirements of each vehicle. For instance, if the brake setting is modified to slow the vehicle gradually before it reaches the common location, the system can reduce fuel consumption that would otherwise be used for sudden deceleration or idling. Likewise, a fine-tuned moving speed adjustment can prevent the vehicle from consuming excessive fuel due to unnecessary acceleration or excessive braking.

In one embodiment, the control circuit may take into account real-time constraints when modifying the operational settings of either vehicle to optimize fuel consumption. These constraints may include one or more of speed limit constraints, operating constraints, vehicle length constraints, vehicle load constraints, or scheduling constraints. Suitable speed limit constraints may include a minimum or maximum speed criterion. This includes speed limits and speed safety constraints, and these may be applied to sections of the route, and may be dynamic insofar as work zones and such may adjust the speed limits temporarily. This may help ensure that the vehicle's speed remains within safe and efficient limits. Suitable operating constraints may include a service time criterion. This may ensure that adjustments to idle, speed or braking do not extend the operator's service time beyond allowable limits. In one embodiment, cargo might have a time sensitive delivery time/date. Examples may include routing passengers vs cargo, perishable goods, disaster relieve deliveries, troop movements, and the like. Suitable vehicle length constraints may include review so that long vehicles can be accommodated within the siding track at or near the common location without causing bottlenecks or operational delays. Suitable vehicle load constraints may affect the vehicle's acceleration, braking, and speed based on the weight of the cargo, minimizing fuel consumption for heavy or light loads. Suitable scheduling constraints may include a scheduling criterion. This may review adjustments to speed or idling time to allow the vehicle to meet its planned schedule without significant delays.

Movement of the first vehicle and/or the second vehicle may include propelling the vehicle forward or backward along a direction of travel, as well as slowing or stopping the vehicle. Movement further may include turning left or right, and increasing or decreasing elevation or depth. Movement further may include determining or setting a vehicle speed, changing a vehicle speed, matching speeds between vehicles. Indirectly, movement of the vehicle may include ramping up (or down) power sources; and this may include energizing electrical circuits or buses, setting fuel flow rates, setting engine RPM rates, and the like. Each route having a top portion. In various embodiments, the top portion of the route may be a running surface, or a resting surface, for a vehicle. Groups of two or more vehicles traveling together in a coordinated manner may be referred to as a consist, swarm, fleet, convoy, fleet and the like. Embodiments may be described in connection with a rail vehicle system, or other types of vehicle systems, such as automobiles, trucks (with or without trailers), buses, marine vessels, aircraft, unmanned aircraft (e.g., drones), mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy). Calculations and computations may be performed on-board the vehicle systems or off-board the vehicle systems and then communicated to the vehicle systems. An on-board or off-board vehicle control system may receive sensor inputs, operator inputs, vehicle parameters, and route parameters, etc.

In one embodiment, a system, includes: a control circuit configured to determine a combined fuel consumption value for a first vehicle and a second vehicle, based at least in part on a first vehicle fuel consumption value and a second vehicle fuel consumption value, with both the first and second vehicles traveling towards, and then through, a common location. The combined fuel consumption determination may be based on at least, a moving fuel consumption value for moving each of the first and second vehicles through the common location, and an idling fuel consumption rate for both the first and second vehicles. Additionally, or alternatively, the control circuit may determine a predicted combined fuel consumption value for a first scenario where the first vehicle moves through the common location while the second vehicle idles and allows the first vehicle to pass, and a second predicted combined fuel consumption value for a second scenario where the second vehicle moves through the common location while the first vehicle idles and allows the second vehicle to pass, and select either the first scenario or the second scenario. Additionally, or alternatively, the control circuit may cause the first vehicle and the second vehicle to enact the first scenario or the second scenario as selected. Additionally, or alternatively, the control circuit may generate a pacing profile for at least one of the first vehicle or the second vehicle to cause at least one of the first vehicle or the second vehicle to arrive at a time otherwise than it would and thereby to both change the amount of time of the second vehicle to idle while allowing the first vehicle to proceed and to reduce the amount of fuel consumption of the first and second vehicles as they both traverse the common location. Additionally, or alternatively, the control circuit may modify at least one of a first trip profile of the first vehicle or a second trip profile of the second vehicle to reduce the combined fuel consumption for both the first and second vehicles to traverse through the common location. Additionally, or alternatively, the control circuit may modify a planned idling parameter to reduce the combined fuel consumption of the first and second vehicles as they traverse the common location. Additionally, or alternatively, the control circuit may modify one or more operational settings to reduce the combined fuel consumption of the first and second vehicles as they traverse the common location, and the operational settings include one or more throttle setting, brake setting, moving speed, tractive effort, and power output. Additionally, or alternatively, the control circuit may restrict or adjust the intended modification in response to one or more of a speed limit constraint, an operating constraint, a vehicle length constraint, a vehicle load constraint, a braking capacity, and a scheduling constraint.

In one embodiment a system includes: a control circuit that determines a combined fuel consumption value for a first vehicle and a second vehicle that are both intended to travel through a common location, based at least in part on first vehicle fuel consumption value that is associated with the first vehicle, and second vehicle fuel consumption value that is associated with the second vehicle, the combined fuel consumption may include: a moving fuel consumption value for moving through the common location; and an idling fuel consumption value for idling at the common location; and the control circuit being further configured to direct one or the other of the first vehicle or the second vehicle to idle at or near the common location based at least in part on a determined collective fuel consumption value for both the first vehicle and the second vehicle. Additionally, or alternatively, the control circuit may control a speed of at least one of the first vehicle or the second vehicle based on a selection of directing one or the other of the first vehicle or the second vehicle, and thereby to affect an arrival time at the common location. Additionally, or alternatively, if the first vehicle would consume more fuel, relative to the second vehicle, during a stop and idle at the common location while the second vehicle continues through the common location without stopping, and the control circuit selects for stopping and idling the first vehicle to continue through the common location without stopping, and the control circuit paces or modifies a trip plan of at least one of the first and second vehicles to cause the second vehicle to arrive at the common location so that it can fully enter a siding off of a mainline, stop, and idle prior to the first vehicle arriving at a siding turn off entrance. Additionally, or alternatively, the control circuit may modify one or more operational settings of the first vehicle, the second vehicle, or both the first and second vehicles thereby to reduce the combined fuel consumption, and the operational settings include one or more throttle setting, brake setting, moving speed, tractive effort, or power output. Additionally, or alternatively, the control circuit may modify one or more operational settings while restrained by one or more of speed limit constraints, operating constraints, or scheduling constraints.

In one embodiment, a method, includes: determining which of a first vehicle and a second vehicle will have priority to move through a common location on a route based at least in part on a predicted first vehicle fuel consumption value for a first vehicle to traverse a route toward and through a common location, and a predicted second vehicle fuel consumption value for the second vehicle to traverse the route toward and through the common location; and the predicted fuel consumption amount is based at least in part on: a moving fuel consumption amount for moving the first and second vehicle through the common location; and an idling fuel consumption amount for idling the first and second vehicles at the common location for the period where the other vehicle traverses the common location. The method may include estimating the moving fuel consumption amount and the idling fuel consumption amount for the first vehicle and the second vehicle. Additionally, or alternatively, the method may include selecting one of the first vehicle or the second vehicle for idling at the common location based at least in part on the estimate. Additionally, or alternatively, the method may include causing one of the first vehicle and second vehicle to stop and idle prior to entering the common location. Additionally, or alternatively, the method may include selecting one of the first vehicle or the second vehicle for idling at the common location based at least in part on the vehicle being equipped with auto engine start stop (AESS). Additionally, or alternatively, the method may include modifying one or more operational settings to reduce the predicted fuel consumption amount, and the operational settings include one or more throttle setting, brake setting, moving speed, tractive effort, and power output. Additionally, or alternatively, the method may include restraining the modification using one or more speed limit constraints, operating constraints, vehicle length constraints, vehicle load constraints, and scheduling constraints.

The foregoing description presents various embodiments of systems and processes through block diagrams, flowcharts, and examples. Each of the depicted components, functions, or operations may be implemented using hardware, software, firmware, or combinations thereof. Specific features can be executed using integrated circuits, computer programs, or processors (e.g., microprocessors, microcontrollers), as well as other software-hardware combinations. The design and development of such implementations, whether via circuitry or software, are within the technical expertise of those skilled in the art. Moreover, the described methods and mechanisms may be distributed as program products on various media, with no restriction on the format of the medium.

Instructions for implementing these features can be stored in various types of memory. Suitable memory may include dynamic random-access memory (DRAM), flash memory, and/or cache. These instructions can be distributed over a network or via other computer-readable media. The term “non-transitory computer-readable medium” refers to any physical medium capable of storing or transmitting instructions or information that can be read by a machine. Examples include, but are not limited to, optical disks, CD-ROMs, RAM, ROM, EPROM, EEPROM, magnetic or optical cards, flash memory, or even propagated signals such as carrier waves or infrared signals.

The term “control circuit” encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and are commonly found in devices such as computers, smartphones, and servers. These circuits may perform tasks involving data processing, communication, or data storage.

In some embodiments, the control circuit can utilize machine learning (ML) techniques to make decisions based on sensor inputs or other data. ML methods may include supervised learning (with labeled inputs and outputs), unsupervised learning (for identifying patterns), or reinforcement learning (where the system adapts based on feedback). tasks for ML systems may involve classification, regression, clustering, anomaly detection, or optimization, with algorithms such as decision trees, deep learning, support vector machines (SVMs), or neural networks being employed, depending on the application.

The system, including the control circuit or controller, may handle data generation, transmission, and storage, potentially leveraging both protected and exposed data sources. Encryption and decryption can be applied during data transit, at rest, or in use, with keys and schemas determined based on operational needs. The control circuit may monitor and enforce decision boundaries, ensuring that data from protected sources meets safety or operational thresholds. If data breaches these boundaries, the system may initiate actions such as equipment shutdown, component isolation, or transitioning to safe mode to mitigate potential risks or damages.

A suitable control circuit may incorporate a policy engine that applies specific rules based on equipment characteristics or environmental conditions. For instance, a neural network could process sensor data or operational inputs to determine appropriate actions. techniques such as backpropagation or evolutionary strategies may be used to refine neural network parameters and optimize model selection for the given task.

In one embodiment, the control circuit, controller, and systems described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model is selected, and the control circuit can execute that plan to achieve the desired input data to mirror the predicted best outcome scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

The term “logic” refers to software, firmware, and/or circuitry configured to execute the described operations. Logic may be implemented as applications, software packages, instruction sets, or data stored on non-transitory computer-readable storage media. Firmware may be hard-coded into memory devices. Components and modules described herein may be hardware, software, or a combination thereof, and may be in active, inactive, or standby states depending on system requirements. An “algorithm” refers to a sequence of steps designed to achieve a specific result. These steps may manipulate physical quantities, typically in the form of electrical or magnetic signals, which are represented as bits, values, symbols, or numbers. The terms used to describe these processes are labels for the underlying physical operations.

Terms such as “processing,” “computing,” “calculating,” or “determining” refer to operations carried out by the control circuit, which may include computing systems or electronic devices that manipulate data represented as physical (electronic) quantities within memory or registers. Terms like “component,” “system,” and “module” refer to computer-related entities, whether hardware, software, or a combination thereof. One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

This written description may disclose several embodiments of the subject matter, including the best mode, and may enable one of ordinary skill in the art to practice the embodiments of subject matter, including making and using any devices or systems and performing any incorporated methods. The patentable scope of the subject matter may be defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A system, comprising:
a control circuit configured to determine a combined fuel consumption value for a first vehicle and a second vehicle, based at least in part on a first vehicle fuel consumption value and a second vehicle fuel consumption value, with both the first and second vehicles traveling towards, and then through, a common location, the combined fuel consumption determination based on at least,
a moving fuel consumption value for moving each of the first and second vehicles through the common location, and
an idling fuel consumption rate for both the first and second vehicles.

2. The system of claim 1, wherein the control circuit is further configured to
determine a predicted combined fuel consumption value for a first scenario where the first vehicle moves through the common location while the second vehicle idles and allows the first vehicle to pass, and a second predicted combined fuel consumption value for a second scenario where the second vehicle moves through the common location while the first vehicle idles and allows the second vehicle to pass, and
select either the first scenario or the second scenario.

3. The system of claim 2, wherein the control circuit is further configured to cause the first vehicle and the second vehicle to enact the first scenario or the second scenario as selected.

4. The system of claim 1, wherein the control circuit is further configured to generate a pacing profile for at least one of the first vehicle or the second vehicle to cause at least one of the first vehicle or the second vehicle to arrive at a time otherwise than it would and thereby to both change the amount of time of the second vehicle to idle while allowing the first vehicle to proceed and to reduce the amount of fuel consumption of the first and second vehicles as they both traverse the common location.

5. The system of claim 1, wherein the control circuit is further configured to modify at least one of a first trip profile of the first vehicle or a second trip profile of the second vehicle to reduce the combined fuel consumption for both the first and second vehicles to traverse through the common location.

6. The system of claim 1, wherein the control circuit is further configured to modify a planned idling parameter to reduce the combined fuel consumption of the first and second vehicles as they traverse the common location.

7. The system of claim 1, wherein the control circuit is further configured to modify one or more operational settings to reduce the combined fuel consumption of the first and second vehicles as they traverse the common location, and the operational settings include one or more throttle setting, brake setting, moving speed, tractive effort, and power output.

8. The system of claim 7, wherein the control circuit is further configured to restrict or adjust the intended modification in response to one or more of a speed limit constraint, an operating constraint, a vehicle length constraint, a vehicle load constraint, a braking capacity, and a scheduling constraint.

9. A system, comprising:
a control circuit configured to determine a combined fuel consumption value for a first vehicle and a second vehicle that are both intended to travel through a common location, based at least in part on first vehicle fuel consumption value that is associated with the first vehicle, and second vehicle fuel consumption value that is associated with the second vehicle, the combined fuel consumption comprising:
a moving fuel consumption value for moving through the common location; and
an idling fuel consumption value for idling at the common location; and
the control circuit being further configured to direct one or the other of the first vehicle or the second vehicle to idle at or near the common location based at least in part on a determined collective fuel consumption value for both the first vehicle and the second vehicle.

10. The system of claim 9, wherein the control circuit is further configured to control a speed of at least one of the first vehicle or the second vehicle based on a selection of directing one or the other of the first vehicle or the second vehicle, and thereby to affect an arrival time at the common location.

11. The system of claim 9, wherein if the first vehicle would consume more fuel, relative to the second vehicle, during a stop and idle at the common location while the second vehicle continues through the common location without stopping, and the control circuit selects for stopping and idling the first vehicle to continue through the common location without stopping, and the control circuit paces or modifies a trip plan of at least one of the first and second vehicles to cause the second vehicle to arrive at the common location so that it can fully enter a siding off of a mainline, stop, and idle prior to the first vehicle arriving at a siding turn off entrance.

12. The system of claim 11, wherein the control circuit is further configured to modify one or more operational settings of the first vehicle, the second vehicle, or both the first and second vehicles thereby to reduce the combined fuel consumption, and the operational settings include one or more throttle setting, brake setting, moving speed, tractive effort, or power output.

13. The system of claim 12, wherein the control circuit is further configured to modify one or more operational settings while restrained by one or more of speed limit constraints, operating constraints, or scheduling constraints.

14. A method, comprising:
determining which of a first vehicle and a second vehicle will have priority to move through a common location on a route based at least in part on a predicted first vehicle fuel consumption value for a first vehicle to traverse a route toward and through a common location, and a predicted second vehicle fuel consumption value for the second vehicle to traverse the route toward and through the common location; and the predicted fuel consumption amount is based at least in part on:
a moving fuel consumption amount for moving the first and second vehicle through the common location; and
an idling fuel consumption amount for idling the first and second vehicles at the common location for the period where the other vehicle traverses the common location.

15. The method of claim 14, further comprising estimating the moving fuel consumption amount and the idling fuel consumption amount for the first vehicle and the second vehicle.

16. The method of claim 15, further comprising selecting one of the first vehicle or the second vehicle for idling at the common location based at least in part on the estimate.

17. The method of claim 16, further comprising causing one of the first vehicle and second vehicle to stop and idle prior to entering the common location.

18. The method of claim 14, further comprising selecting one of the first vehicle or the second vehicle for idling at the common location based at least in part on the vehicle being equipped with auto engine start stop (AESS).

19. The method of claim 14, further comprising modifying one or more operational settings to reduce the predicted fuel consumption amount, and the operational settings include one or more throttle setting, brake setting, moving speed, tractive effort, and power output.

20. The method of claim 14, further comprising restraining the modification using one or more speed limit constraints, operating constraints, vehicle length constraints, vehicle load constraints, and scheduling constraints.
